(19) United States
(12) Patent Application Publication
(10) Pub. No.: US 2025/0227717 A1
(43) Pub. Date: Jul. 10, 2025

(54) TIMER OPERATION FOR MULTI-STAGE DOWNLINK CONTROL INFORMATION (DCI)

(71) Applicant: QUALCOMM Incorporated, San Diego, CA (US)

(72) Inventors: Le LIU, San Jose, CA (US); Huilin XU, Temecula, CA (US); Gabi SARKIS, San Diego, CA (US)

(21) Appl. No.: 18/409,740

(22) Filed: Jan. 10, 2024

(51) Int. Cl. H04W 72/232; H04W 72/1273

(52) U.S. Cl. CPC H04W 72/232; H04W 72/1273

(57) ABSTRACT

Aspects of the disclosure are directed to wireless node operations where a multi-stage downlink control information (DCI) messaging scheme is employed. More specifically, the disclosure describes timer operations used by the wireless node within the context of the multi-stage DCI messaging scheme. In some examples, the wireless node may obtain a first-stage DCI configured to schedule transmission of a second-stage DCI. In some examples, the wireless node may obtain the second-stage DCI, and in response to one or both of the first- and second-stage DCI, the wireless node may start or restart a timer.

### BACKGROUND

### Technical Field

The present disclosure generally relates to communication systems, and more particularly, to timer operations for multi-stage downlink control information (DCI) messages.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a wireless node. In some examples, the method includes obtaining a first-stage downlink control information (DCI) of a multi-stage DCI messaging scheme, wherein the first-stage DCI is configured to schedule transmission of a second-stage DCI. In some examples, the method includes obtaining the second-stage DCI. In some examples, the method includes starting or restarting a timer after receiving at least one of the first-stage DCI or the second-stage DCI.

Certain aspects are directed to a method for wireless communication at a network entity. In some examples, the method includes outputting, for transmission to a wireless node, a configuration message configuring the wireless node to start or restart a timer in response to reception of at least one of a first-stage downlink control information (DCI) or a second-stage DCI, wherein the first-stage DCI and the second-stage DCI are part of a multi-stage DCI messaging scheme. In some examples, the method includes outputting the first-stage DCI for transmission to the wireless node, wherein the first-stage DCI is configured to schedule transmission of the second-stage DCI.

Certain aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors, individually or in combination, are configured to obtain a first-stage downlink control information (DCI) of a multi-stage DCI messaging scheme, wherein the first-stage DCI is configured to schedule transmission of a second-stage DCI. In some examples, the one or more processors, individually or in combination, are configured to obtain the second-stage DCI. In some examples, the one or more processors, individually or in combination, are configured to start or restart a timer after receiving at least one of the first-stage DCI or the second-stage DCI.

Certain aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors, individually or in combination, are configured to output, for transmission to a user equipment (UE), a configuration message configuring the UE to start or restart a timer in response to reception of at least one of a first-stage downlink control information (DCI) or a second-stage DCI, wherein the first-stage DCI and the second-stage DCI are part of a multi-stage DCI messaging scheme. In some examples, the one or more processors, individually or in combination, are configured to output the first-stage DCI for transmission to the UE, wherein the first-stage DCI is configured to schedule transmission of the second-stage DCI.

Certain aspects are directed to an apparatus for wireless communication. In some examples, the apparatus includes means for obtaining a first-stage downlink control information (DCI) of a multi-stage DCI messaging scheme, wherein the first-stage DCI is configured to schedule transmission of a second-stage DCI. In some examples, the apparatus includes means for obtaining the second-stage DCI. In some examples, the apparatus includes means for starting or restarting a timer after receiving at least one of the first-stage DCI or the second-stage DCI.

Certain aspects are directed to an apparatus for wireless communication. In some examples, the apparatus includes means for outputting, for transmission to a wireless node, a configuration message configuring the wireless node to start or restart a timer in response to reception of at least one of a first-stage downlink control information (DCI) or a second-stage DCI, wherein the first-stage DCI and the second-stage DCI are part of a multi-stage DCI messaging scheme. In some examples, the apparatus includes means for outputting the first-stage DCI for transmission to the wireless node, wherein the first-stage DCI is configured to schedule transmission of the second-stage DCI.

Certain aspects are directed to a non-transitory computer-readable medium comprising instructions that, when executed by a wireless node, cause the wireless node to perform an operation. In some examples, the operation includes obtaining a first-stage downlink control information (DCI) of a multi-stage DCI messaging scheme, wherein the first-stage DCI is configured to schedule transmission of a second-stage DCI. In some examples, the operation includes obtaining the second-stage DCI. In some examples, the operation includes starting or restarting a timer after receiving at least one of the first-stage DCI or the second-stage DCI.

Certain aspects are directed to a non-transitory computer-readable medium comprising instructions that, when executed by a network entity, cause the network entity to perform an operation. In some examples, the operation includes outputting, for transmission to a wireless node, a configuration message configuring the wireless node to start or restart a timer in response to reception of at least one of a first-stage downlink control information (DCI) or a second-stage DCI, wherein the first-stage DCI and the second-stage DCI are part of a multi-stage DCI messaging scheme. In some examples, the operation includes outputting the first-stage DCI for transmission to the wireless node, wherein the first-stage DCI is configured to schedule transmission of the second-stage DCI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example of a two-stage downlink control information (DCI) transmission.

FIG. 6 is a call-flow diagram illustrating example communications between a wireless node and a network entity.

FIG. 7 is another call-flow diagram illustrating example communications between a wireless node and a network entity.

FIG. 8 is another call-flow diagram illustrating example communications between a wireless node and a network entity.

FIG. 9 is a flowchart of a method of wireless communication.

FIG. 10 is a diagram illustrating an example of a hardware implementation for an apparatus.

FIG. 11 is a flowchart of a method of wireless communication.

FIG. 12 is a diagram illustrating an example of a hardware implementation for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Downlink control information (DCI) is a type of control information that is transmitted from a network entity (e.g., a base station) to a wireless node (e.g., a user equipment (UE)) to manage communication, such as scheduling resource allocation, power control instructions, and other network communication details. New radio (NR) standards introduced a single-stage DCI design that offered enhanced flexibility for scheduling different services with various quality of service (QoS) requirements, relative to the DCI of long-term evolution (LTE) standards.

However, the single-stage DCI may have some inherent limitations in certain aspects relative to a multi-stage DCI. For example, relative to a single-stage DCI, a two-stage DCI may enhance downlink processing time at a wireless node. Specifically, with two-stage DCI, the network entity can schedule downlink resources before receiving an ACK for a previous physical downlink shared channel (PDSCH) transmission, thereby allowing the wireless node to start reference signal (RS) processing and channel estimation at an earlier time.

Moreover, a two-stage DCI may provide an enhanced uplink processing time at the network entity. For example, the wireless node may prepare uplink data upon receiving an initial first-stage DCI, allowing data to be transmitted quickly after a second-stage DCI is subsequently received and decoded. In some examples, a first-stage DCI message of a two-stage DCI may be a common size among different first-stage DCI formats. Thus, the first-stage may have a single size regardless of the format, which may reduce the complexity of blind detection. In other words, the wireless node will have fewer candidate resources to monitor for potential messages, making the process of receiving the first-stage DCI messages relatively more efficient and reducing the complexity of their decoding.

In some examples, a first-stage DCI may provide common scheduling information for multiple downlink and/or uplink transmissions (e.g., for semi-persistent scheduling), and subsequent second-stage DCIs may provide link adaptation scheduling information. For example, the second-stage DCI may provide specific information like a modulation and coding scheme (MCS) for link adaptation for a particular transmission. In yet another example, a first-stage DCI message may be transmitted on a wider beam for better coverage, and a subsequent second-stage DCI may be transmitted on a narrower beam for enhanced spectral efficiency relative to a single-stage DCI transmission.

However, implementation of a two-stage DCI may impact timer operations. In mobile networks, a variety of different timers may be used for different purposes. Some timers may be used to manage how a wireless node communicates with a network entity. For example, timers may control and manage the time and frequency resources, as well as the power used by the wireless node. In some examples, such timers may be started or stopped based on DCI signals received from a network entity. As such, these timers may be adversely affected if a single-stage DCI communication is replaced by a two-stage DCI communication.

Accordingly, aspects of the disclosure are directed to how certain timers may be configured in a two-stage DCI scenario in order to provide and maintain coherent communications between wireless devices.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

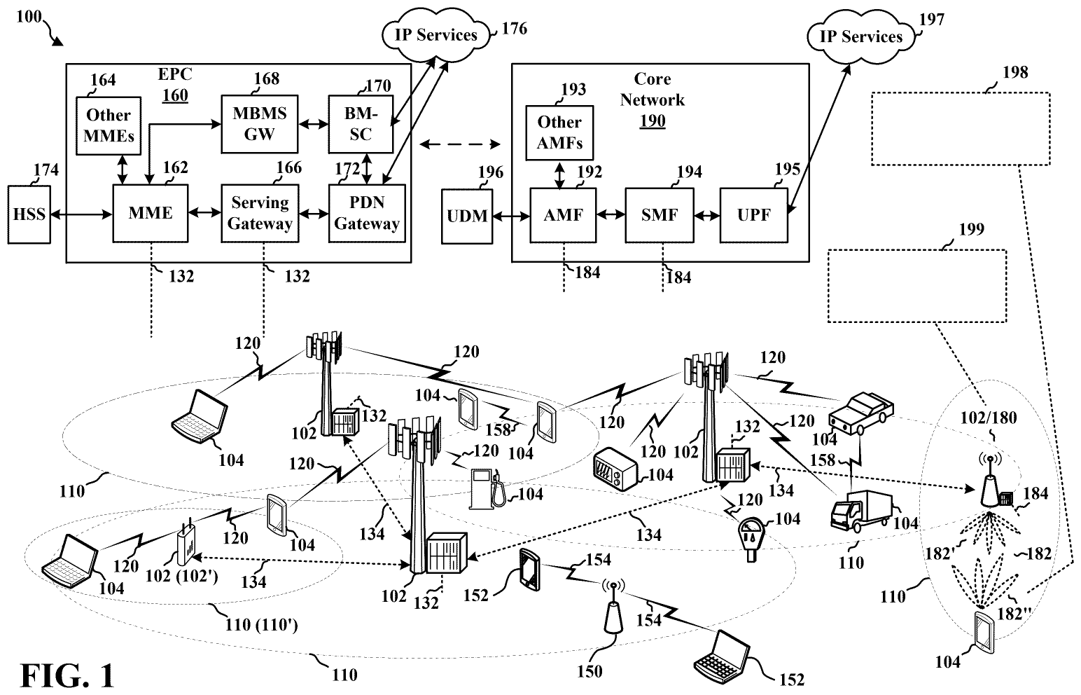

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

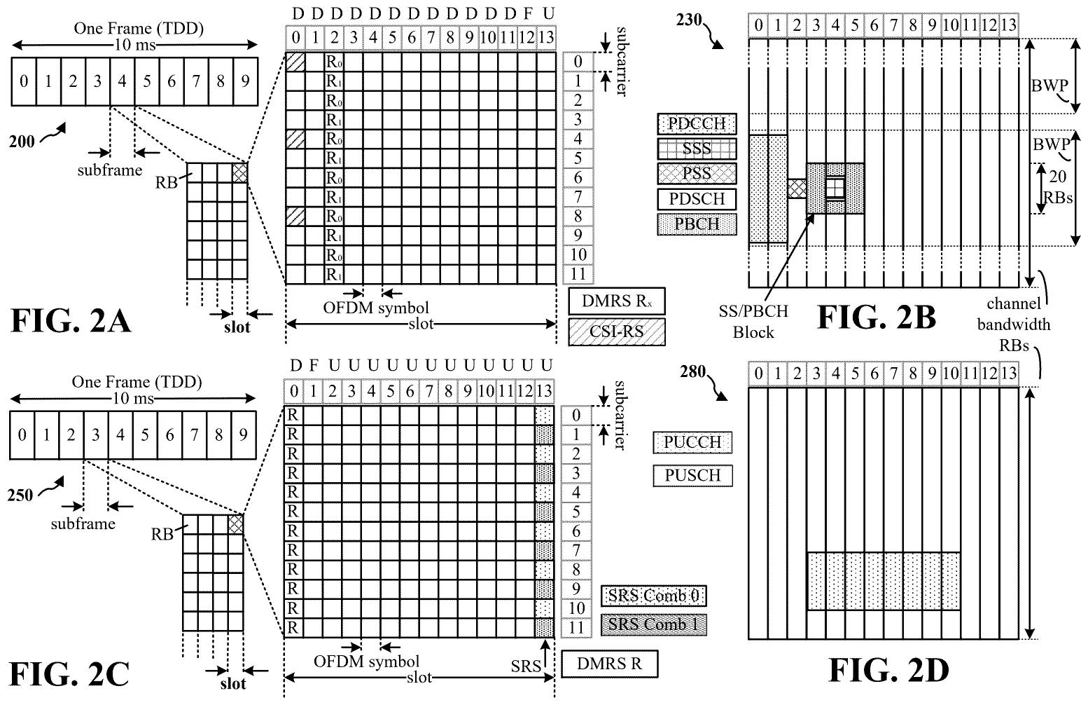

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

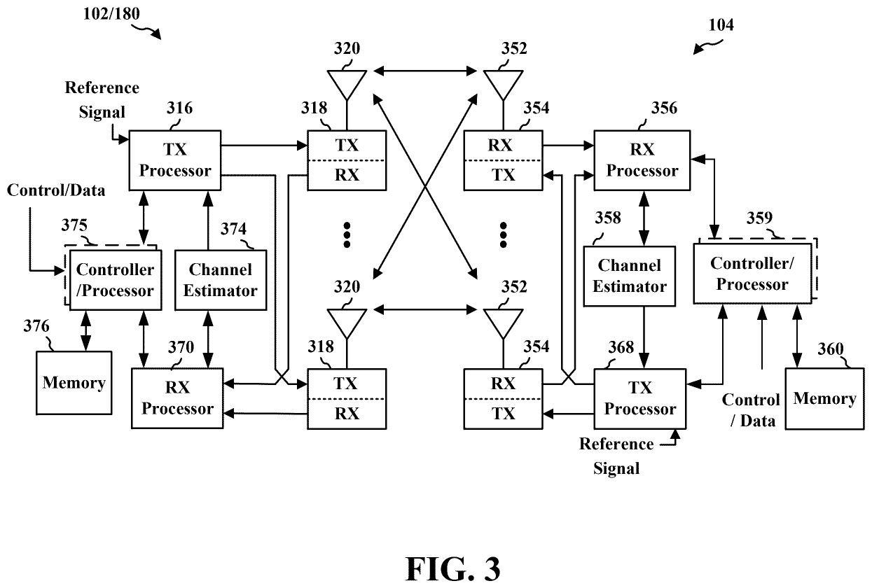

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

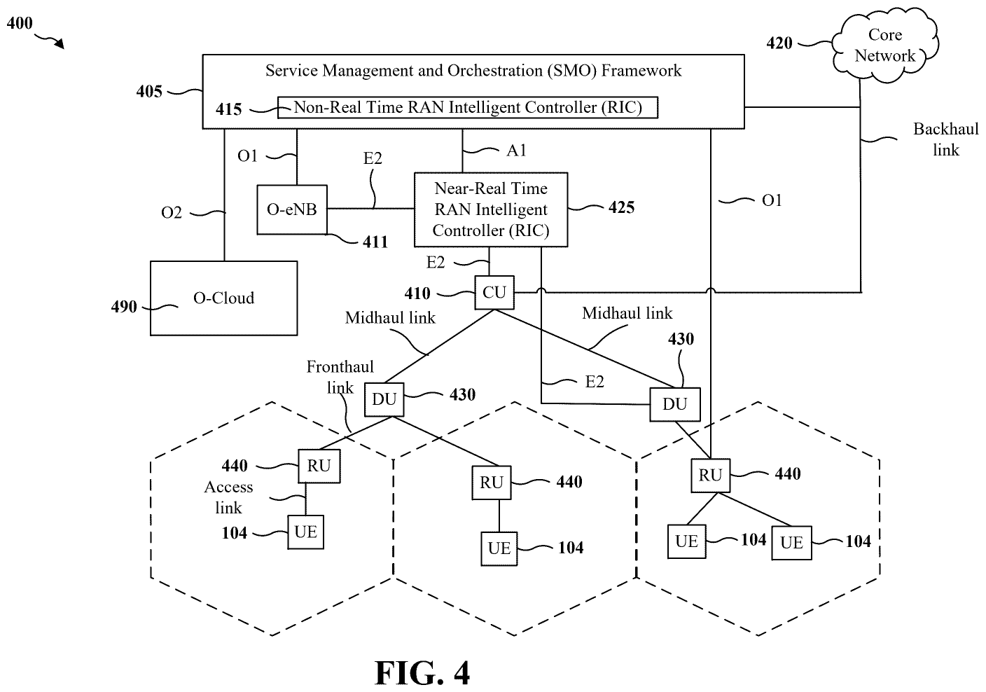

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Multi-Stage DCI

Traditional DCI mechanisms are single-stage and transmitted via PDCCH. Scheduling information received via the single-stage DCI can be obtained through blind detection of PDCCH candidates in a search space. However, relative to two-stage DCI, blind detection may be rather complex, resulting in a relatively high detection latency. Two-stage DCI divides a scheduling DCI into two partial transmissions.

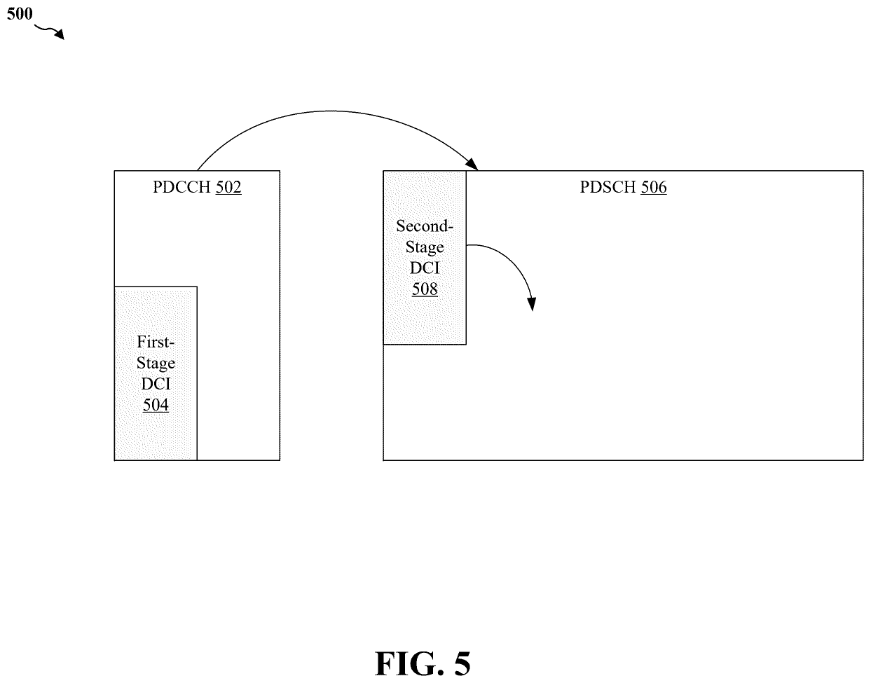

FIG. 5 is a block diagram illustrating an example of a two-stage DCI transmission 500. Here, a first-stage DCI 504 is transmitted via a PDCCH 502, an contains the resource information of a second-stage DCI 508 so that the receiver (e.g., UE 104 or network entity 102/180) can determine the resources for the second-stage DCI without performing blind detection for the second-stage DCI. The second-stage DCI may be in another PDCCH resource region (e.g., a future PDCCH) or in the PDSCH 506 resource region, as scheduled by the first-stage DCI 504.

As illustrated, a wireless node may find and decode the second-stage DCI 508 within the PDSCH 506 and obtain additional scheduling information from the second-stage DCI 508. Dividing the DCI into two partial DCI transmissions simplifies the reception of the second-stage DCI 508, saves the wireless node's power consumption in searching for second-stage DCI, and reduces the overhead of PDCCH due to the offloading of the second-stage DCI into the PDSCH 506 resource region.

### Examples of Timers Used in Wireless Communications

In mobile networks like 4G LTE and 5G NR, different timers may be used to control or manage aspects of device functionality. Some of these timers may be started or stopped based on signals, such as a DCI signal, received from a network entity.

One of these timers is a discontinuous reception (DRX) timer (e.g., drx-onDurationTimer). The DRX timer may be used to manage power consumption of a device. For example, a wireless node may maintain a DRX timer that allows it to ‘sleep’ or enter into a low power state when no data is being transmitted or received during the duration of the timer. If the wireless node receives a DCI indicating a new transmission (e.g., uplink or downlink), the wireless node may reset or restart the DRX timer, and the wireless node may wake up from a sleep state or continue operating in an awake state.

There's also a bandwidth part (BWP) inactivity timer (e.g., bwp-InactivityTimer) in NR applications. This timer may be used for switching between different BWPs used by the wireless node. For example, if a wireless node receives a DCI for uplink or downlink on an active BWP, the timer is (re)started and the wireless node continues communicating via the active BWP. If the wireless node does not receive or transmit any signaling on a particular BWP for the duration of the timer, the wireless node may switch or fallback to another BWP.

Another timer includes an activation/deactivation timer (e.g., sCellDeactivationTimer) for activating or deactivating secondary cells. For example, a secondary cell may provide a secondary component carrier in a carrier aggregation scenario. If the wireless node receives a DCI on activated secondary cell, the timer restarts; however, if no signaling is transmitted or received via the secondary cell for the duration of the timer, the wireless node may deactivate (e.g., stop monitoring) the secondary cell.

Another timer (e.g., searchSpaceSwitchTimer) may be associated with search space set group (SSSG) switching and used for switching between different search spaces. For example, a wireless node may monitor different search spaces to find signals from a network entity. The wireless node may switch from one search space to another based on an SSSG switching timer. If the wireless node detects a PDCCH or other suitable signaling (e.g., a DCI) in a search space it is currently monitoring, then the wireless node may reset the SSSG switching timer. In other words, the wireless node may continue to monitor the same search space for signals if it detects the appropriate signals in that search space. If the wireless node does not detect signaling in the currently active search space for the duration of the timer (e.g., if the timer runs out), then the expiration of the timer may trigger the wireless node to switch to a different search space.

Additional timers may be used by a wireless node for full duplex switching. Here, one or more timers may be used to switch between full duplex (e.g., transmitting and receiving data at the same time) and half duplex (e.g., either sending or receiving data) communication techniques. For example, if the wireless node is operating in full duplex, and it detects full duplex signaling (e.g., a DCI scheduling a full duplex uplink or downlink communication), the wireless node may reset the timer to continue communicating in full duplex. If the wireless node does not detect full duplex signaling for the duration of the timer, it may switch to half duplex communications.

Accordingly, a DCI transmission from a network entity may influence these timers, which in turn control various aspects of how the wireless node communicates with the network. Thus, in order to maintain effectivity of the timers and ensure efficient communication and operation in a two-stage DCI scenario, aspects of the disclosure are directed to timer operations in the two-stage DCI scenario.

It should be noted that the aforementioned timers are examples and do not constitute an exhaustive list of timers that may be affected by DCI signaling. Thus, aspects of the disclosure include any other timers that may be affected by DCI signaling, including but not limited to a HARQ feedback timer, an RRC connection release timer, a retransmission timer, etc.

### Examples of Timer Operation in a Two-Stage DCI Scenario

In a two-stage DCI scenario, a network entity (e.g., base station 102/180 of FIGS. 1 and 3) may initially transmit a first-stage DCI and subsequently transmit a second-stage DCI. In some examples, the first-stage DCI may be transmitted via PDCCH and it may indicate one or multiple second-stage DCIs. In other words, the first-stage DCI may provide initial information about the upcoming one or more second-stage DCIs and/or a future uplink or downlink data transmission, including a timing of the second-stage DCI(s) and/or data transmission, a frequency band to be used for the second-stage DCI(s) and/or data transmission, and/or a format of the second-stage DCI(s) and/or data transmission. Thus, the first-stage DCI may configure a wireless node (e.g., UE 104 of FIGS. 1 and 3 or another network entity) so that it is ready to receive the second-stage DCI and/or transmit/receive a data transmission.

The second-stage DCI may be transmitted via PDCCH or PDSCH, and may provide additional instructions and/or parameters for a data transmission. For example, the second-stage DCI may provide an indication of a data rate for a data transmission, a modulation scheme to be used for the data transmission, a coding rate for error protection, and/or any suitable additional information. Accordingly, in some examples, the relationship between the first-stage and second-stage DCI is sequential and complementary. The first-stage DCI may prepare the wireless node for an upcoming transmission (e.g., either uplink or downlink) and the second-stage DCI may provide instructions needed to carry out the transmission.

In certain aspects, a wireless node may reset one or more of the aforementioned timers when it receives a first-stage DCI. For example, the receipt of a first-stage DCI may trigger the wireless node to (re)start one or more timers. In one example, the wireless node may restart a timer at the first symbol or slot after the end of the PDCCH reception. In other words, a timer may be started or restarted at the beginning of the next symbol or slot after the wireless node receives the PDCCH that carries the first-stage DCI. As such, the timer may be started or restarted regardless of whether or when the wireless device receives or detects a second-stage DCI. Moreover, the wireless node may refrain from taking any action on the timer(s) in response to receiving a second-stage DCI. Thus, if the second-stage DCI is transmitted via PDSCH (which is generally used for data transmission) or PDCCH (which is generally used for control information), it may not trigger the wireless node to take any action on the timer(s). Therefore, in some examples, the operation of one or more timers may be primarily linked to the detection of a first-stage DCI, regardless of the second-stage DCI's presence or timing.

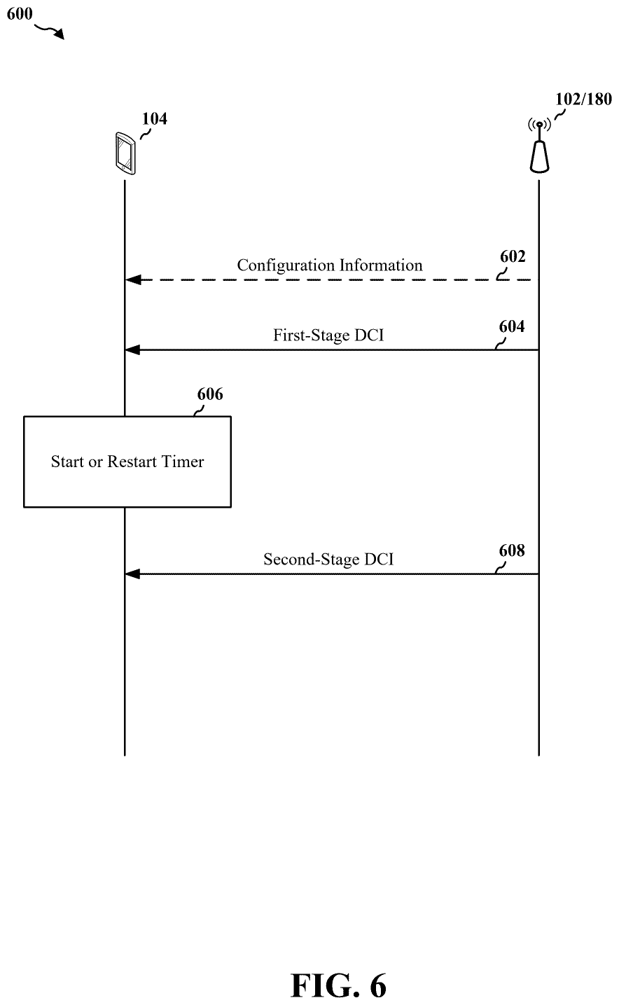

FIG. 6 is a call-flow diagram illustrating example communications 600 between a wireless node (e.g., UE 104 of FIGS. 1 and 3) and a network entity (e.g., base station 102/180 of FIGS. 1 and 3). At an optional first communication 602, the network entity 102/180 may transmit configuration information to the wireless node 104. The transmission may include information for configuring the wireless node 104 to (re)start one or more timers in response to receiving a first-stage DCI from the network entity 102/180. In some examples, the information may indicate a time (e.g., slot or symbol) during which the wireless device 104 may reset the timer (e.g., a time relative to the time the first-stage DCI is received). In some examples, the information may indicate which one or more timers the wireless device 104 may reset in response to receiving a first-stage DCI.

At a second communication 604, the network entity 102/180 may transmit a first-stage DCI to the wireless node 104. The first-stage DCI may be transmitted via PDCCH and may schedule or otherwise notify the wireless device 104 of a future second-stage DCI transmission.

At a first process 606, the wireless device 104 may (re)start one or more timers based on the configuration information and/or in response to receiving the first-stage DCI.

At a third communication 608, the network entity 102/180 may transmit a second-stage DCI. In some examples, the wireless node 104 may refrain from taking any action on the one or more timers in response to the second-stage DCI.

In certain aspects, a wireless node may be configured in a way such that a second-stage DCI triggers the wireless node to re(start) one or more timers. In one example, the wireless node may start or restart a timer when it detects the second-stage DCI, which may indicate a new data transmission, regardless of whether or when the device detects the associated first-stage DCI. For example, the first-stage DCI may configure the wireless node for semi-persistent scheduling, where the wireless device monitors for a second-stage DCI at periodic intervals or indicated time and frequency resources. As such, using a first-stage DCI, the network entity may set up multiple possible second-stage DCI transmissions in advance so that each second-stage DCI is not preceded or heralded by its own dedicated first-stage DCI. However, in such an example, the network entity may not transmit a first-stage DCI at each interval or indicated resource. Thus, in this example, the wireless node may refrain from taking any action on one or more timers in response to receiving the first-stage DCI, and instead, wait until it receives a second-stage DCI to (re)start the timer(s). In some examples, the wireless node may (re)start the one or more timers at the first symbol or slot following the end of the PDCCH or PDSCH carrying the second-stage DCI. Accordingly, in certain aspects, how the wireless node operates the timer may be primarily linked to the detection of the second-stage DCI, regardless of the first-stage DCI's presence or timing.

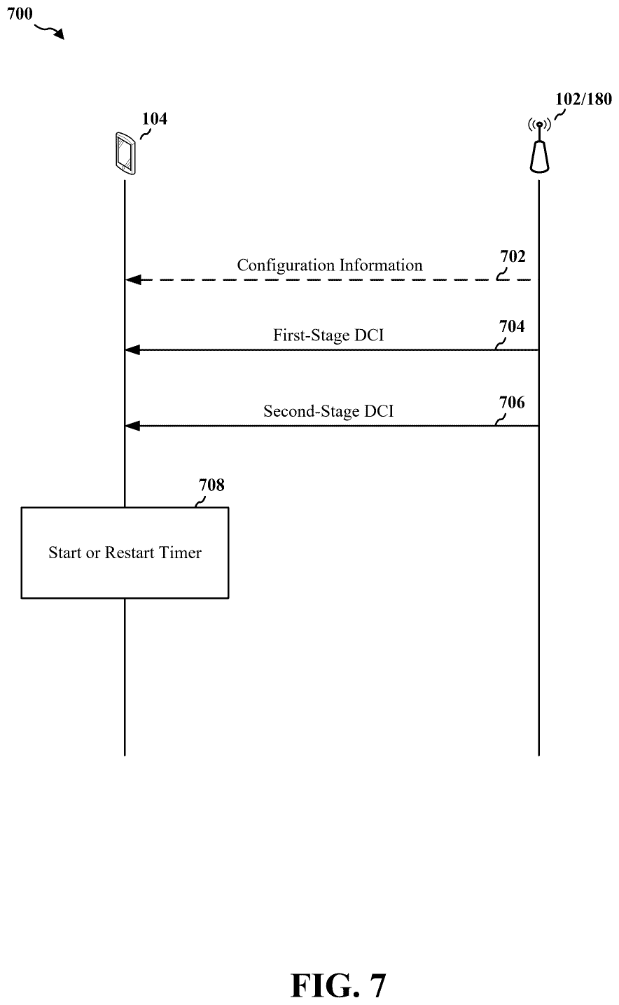

FIG. 7 is a call-flow diagram illustrating example communications 700 between a wireless node (e.g., UE 104 of FIGS. 1 and 3) and a network entity (e.g., base station 102/180 of FIGS. 1 and 3). At an optional first communication 702, the network entity 102/180 may transmit configuration information to the wireless node 104. The transmission may include information for configuring the wireless node 104 to (re)start one or more timers in response to receiving a second-stage DCI from the network entity 102/180. In some examples, the information may indicate a time (e.g., slot or symbol) during which the wireless device 104 may reset the timer (e.g., a time relative to the time that the second-stage DCI is received). In some examples, the information may indicate which one or more timers the wireless device 104 may reset in response to receiving a first-stage DCI. In some examples, the information may indicate which second-stage DCI (e.g., the X^{th} second-stage DCI of multiple-second-stage DCIs scheduled by the first-stage DCI) in response to which the wireless node 104 may (re)start a timer.

At a second communication 704, the network entity 102/180 may transmit a first-stage DCI to the wireless node 104. The first-stage DCI may be transmitted via PDCCH and may schedule or otherwise notify the wireless device 104 of a future second-stage DCI transmission. Here, the wireless node 104 may refrain from taking any action on one or more timers in response to receiving the first-stage DCI.

At a third communication 706, the network entity 102/180 may transmit a second-stage DCI to the wireless node 104. The second-stage DCI may be associated with the first-stage DCI (e.g., scheduled by the first-stage DCI). The second-stage DCI may be one of one or more second-stage DCIs scheduled via the first-stage DCI.

At a first process 708, the wireless device 104 may (re)start one or more timers based on the configuration information and/or in response to receiving the second-stage DCI.

In certain aspects, the wireless node's operation of a timer may be linked to the detection of both first- and second-stage DCIs. In one example, the wireless node may be triggered to (re)start a timer in response to detecting both a first-stage DCI and one or more second-stage DCI(s) associated with the first-stage DCI. In other words, the wireless node may start or restart one or more timers when it detects both the first-stage DCI and all or a subset of the associated second-stage DCIs. An associated second-stage DCI may relate to a second-stage DCI that is scheduled by a previous first-stage DCI or is expected by the wireless node based on a preceding first-stage DCI. Accordingly, in some examples, the wireless node may re(start) one or more timers in response to receiving the contents included in a first-stage DCI or one or more associated second-stage DCIs, which may indicate a new transmission. In some examples, a timer may be (re)started in a first symbol or slot immediately following the end of the PDCCH or PDSCH carrying the second-stage DCI. In another example, if the first-stage DCI indicates multiple second-stage DCIs, the wireless node may (re)start the timer at the start of the next symbol or slot after it finishes receiving the X^{th} PDCCH or PDSCH that carried the second-stage DCI. Here, X may be a predefined number or a number pre-configured by the network entity and communicated to the wireless node via an RRC message.

In another example, the first-stage DCI indicates whether to (re)start the timer if the associated second-stage DCI(s) are detected. Here, the wireless node receives the first-stage DCI, and a DCI field or RNTI within in the first-stage DCI or search space set associated with the first-stage DCI may indicate whether to (re)start a timer, which may be selected among multiple timer durations if configured, upon receiving the associated second-stage DCI(s). The configuration information of the first communication 702 or an RRC configuration may provide the wireless node 104 with values of DCI field or RNTI and/or resources used for transmitting the DCI field or RNTI that indicate whether the wireless node 104 may (re)start the indicated timer.

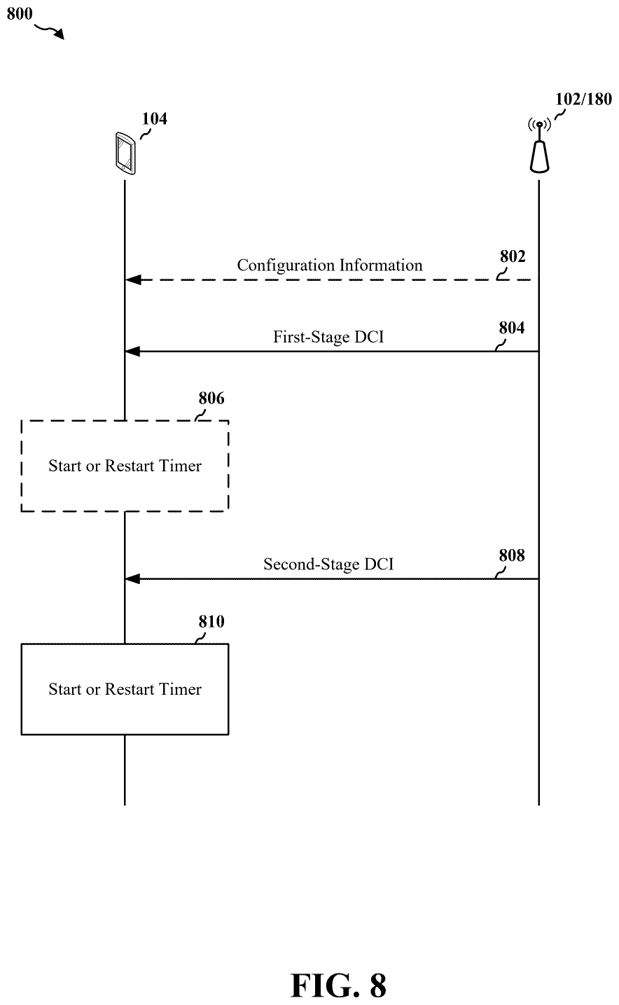

FIG. 8 is a call-flow diagram illustrating example communications 800 between a wireless node (e.g., UE 104 of FIGS. 1 and 3) and a network entity (e.g., base station 102/180 of FIGS. 1 and 3). At an optional first communication 802, the network entity 102/180 may transmit configuration information to the wireless node 104. The transmission may include information for configuring the wireless node 104 to (re)start one or more timers in response to receiving a first-stage DCI and/or (re)start one or more timers (e.g., the same of different timers the wireless node 104 acts upon in response to the first-stage DCI) in response to receiving a second-stage DCI. In some examples, the information may indicate a time (e.g., slot or symbol) during which the wireless device 104 may reset the timer (e.g., a time relative to the time that the first- and/or second-stage DCI is received). In some examples, the information may indicate which one or more timers the wireless device 104 may reset in response to receiving a first-stage DCI and/or an associated second-stage DCI. In some examples, the information may indicate which second-stage DCI (e.g., the X, second-stage DCI of multiple-second-stage DCIs scheduled by the first-stage DCI, or the X, second-stage DCI received via PDCCH or PDSCH) in response to which the wireless node 104 may (re)start a timer.

At a second communication 804, the network entity 102/180 may transmit a first-stage DCI to the wireless node 104. The first-stage DCI may be transmitted via PDCCH and may schedule or otherwise notify the wireless device 104 of a future second-stage DCI transmission. Here, the wireless node 104 may refrain from taking any action on one or more timers in response to receiving the first-stage DCI, or may optionally (re)start one or more timers in response to receiving the first-stage DCI.

At an optional first process 806, the wireless device 104 may (re)start one or more timers based on the configuration information and/or in response to receiving the first-stage DCI.

At a third communication 808, the network entity 102/180 may transmit a second-stage DCI to the wireless node 104. The second-stage DCI may be associated with the first-stage DCI (e.g., scheduled by the first-stage DCI). The second-stage DCI may be one of one or more second-stage DCIs scheduled via the first-stage DCI.

At a second process 810, the wireless device 104 may (re)start one or more timers based on the configuration information and/or in response to receiving the second-stage DCI. In some examples, the wireless device 104 may (re)start one or more timers in response to receiving X number of second-stage DCIs scheduled by the first-stage DCI.

It should be noted that the wireless node 104 may be configured to (re)start one or more timers in response to the first-stage DCI of the second communication 804 at the optional first process 806, while also configured to (re)start one or more timers in response to the second-stage DCI of the third communication 808. In one example, there may be some overlap in the timers that the wireless node 104 is configured to (re)start in response to the first- and second-stage timers. However, in some examples, there may be no overlap in the timers.

In certain aspects, the wireless node 104 may be configured so that one or more timers are common between single-stage DCI messaging and two-stage DCI messaging. For example, if the network entity 102/180 communicates with the wireless node 104 via both single-stage and two-stage DCI, then the wireless node 104 may include one or more common timers shared by the single-stage and two-stage DCI. If the network entity 102/180 communicates with the wireless node 104 via single-stage and another network entity communicated via two-stage DCI, then the wireless node 104 may include one or more common timers.

For example, the network entity 102/180 may configure the wireless node 104 (e.g., via the first communication 602/702/802) with configuration information identifying which timer(s) are common for both single-stage and two-stage DCI. In some examples, the configuration information may also indicate a duration of the common timer(s). For example, the network entity 102/180 may configure the wireless node 104 to use a common timer duration for a DRX inactivity timer for both single-stage and two-stage DCI. In another example, the wireless node may be configured to use two separate DRX inactivity timers of different duration for single-stage and two-stage DCIs. Here, the BWP inactivity timer for single-stage DCI may be a shorter duration relative to a longer duration of the DRX inactivity timer for two-stage DCI (e.g., single-stage DCI may be used to schedule relatively bursty traffic with a low-latency requirement, whereas two-stage DCI may be used to schedule other traffic types).

In certain aspects, the wireless node 104, if using the two-stage DCI, may be configured such that one or more timers are common between the first-stage DCI messaging and second-stage DCI messaging. For example, a DRX timer having the same duration may be used for both the first-stage DCI and the second-stage DCI. In some examples, the wireless node 104 may be configured with separate timers for the first-stage and second-stage DCIs. For example, the DRX inactivity timer for the first-stage DCI may be defined by a first duration, and the DRX inactivity timer for the second-stage DCI may be defined by a second duration that is longer or shorter than the first duration. Here, the first duration may be a longer duration than the second duration because the first-stage DCI may be monitored in a search space with longer periodicity. The second-stage DCI may monitored a search space with shorter periodicity, thus it may use a shorter duration for the same timer.

In certain aspects, the first- and second-stage DCIs may be transmitted in different search spaces (e.g., different CORESETs and/or different BWPs, etc.) and/or in different component carriers (CCs) in a carrier aggregation scenario. Accordingly, timer operations may be configured for different purposes and thus, they may indicate different content or instructions for the wireless node 104.

For example, in a DRX operation involving a DRX on-duration timer (e.g., drx-onDurationTimer) and a DRX inactivity timer (e.g., drx-InactivityTimer), the inactivity timer may be restarted if the first- and/or second-stage DCI indicates a new transmission (e.g., downlink, uplink, sidelink) by a network entity (e.g., serving cell) in a DRX group during the time the MAC entity of the wireless node 104 is active.

In an example relating to BWP switching with BWP inactivity timer (e.g., bwp-InactivityTimer), the inactivity timer may be restarted if the first-stage DCI indicates a downlink assignment or uplink grant for unicast/multicast data to be transmitted via the active BWP.

In an example relating to SCell activation/deactivation with deactivation timer (e.g., sCellDeactivationTimer), the timer associated with the SCell may be (re)started if the wireless node 104 receives both the first- and second-stage DCIs from the active SCell indicating an uplink grant or a downlink assignment. In another example, the timer may be (re)started if the wireless node 104 receives the first-stage DCI on a PCell or serving cell indicating an uplink grant or a downlink assignment of the active SCell.

In an example relating to SSSG switching with an SSSG switching timer (e.g., searchSpaceSwitchTimer), the timer may be reset after receiving a downlink transmission via an active downlink BWP of the network entity if the wireless node 104 detects a second-stage DCI in a Type3-common search space (CSS) and/or UE specific search space (USS) for unicast (or multicast) in the downlink transmission. In this example, the first-stage DCI may not be in Type3-CSS or USS.

In an example relating to full-duplex switching, a full-duplex inactivity timer may be configured to allow the wireless node 104 to determine when to fall back to half-duplex operation. In some examples, the wireless node 104 may (re)start the inactivity timer to maintain full-duplex operation if the wireless node 104 detects a first-stage DCI scheduling a full duplex transmission.

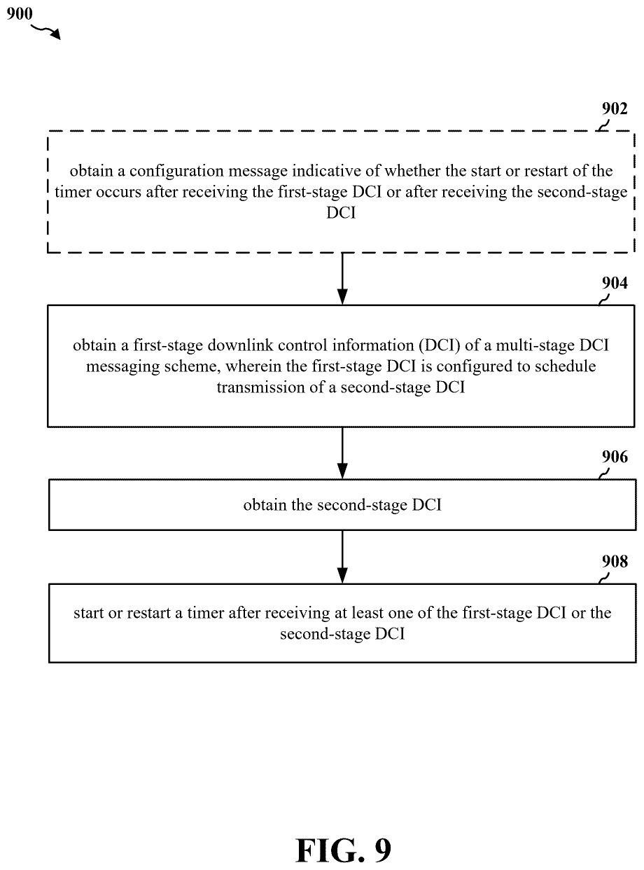

FIG. 9 is a flowchart 900 of a method of wireless communication. The method may be performed by a UE (e.g., the UE 104; the apparatus 1002). Specifically, the method may be performed by one or more processors (e.g., the controller/processor 359, the Rx processor 356, the Tx processor 368, etc., of FIG. 3).

At 902, the UE may optionally obtain a configuration message indicative of whether the start or restart of the timer occurs after receiving the first-stage DCI or after receiving the second-stage DCI. For example, 902 may be performed by an obtaining component 1040.

At 904, the UE may obtain a first-stage downlink control information (DCI) of a multi-stage DCI messaging scheme, wherein the first-stage DCI is configured to schedule transmission of a second-stage DCI. For example, 904 may be performed by the obtaining component 904.

At 906, the UE obtain the second-stage DCI. For example, 906 may be performed by the obtaining component 906.

At 906, the UE may start or restart a timer after receiving at least one of the first-stage DCI or the second-stage DCI. For example, 906 may be performed by a (re)starting component 1042.

In certain aspects, the configuration message is further indicative of at least one of a time at which the start or restart of the timer occurs.

In certain aspects, the first-stage DCI is further configured to schedule transmission of multiple second-stage DCIs including the second-stage DCI, and wherein the configuration message is further indicative of the second-stage DCI triggering the start or restart of the timer.

In certain aspects, the timer is configured with a duration of time for operations associated with both a single-stage DCI messaging scheme and the multi-stage DCI messaging scheme.

In certain aspects, the timer is configured with a first duration of time for operations associated with a single-stage DCI messaging scheme, wherein the timer is configured with a second duration of time for operations associated with the multi-stage DCI messaging scheme, and wherein the first duration of time is different than the second duration of time.

In certain aspects, the timer is configured with a duration of time for both the first-stage DCI and the second-stage DCI.

In certain aspects, the timer is configured with a first duration of time for operations associated with first-stage DCI, wherein the timer is configured with a second duration of time for operations associated with the second-stage DCI, and wherein the first duration of time is different than the second duration of time.

In certain aspects, the timer is a discontinuous reception (DRX) inactive timer, and wherein the timer is started or restarted if at least one of the first-stage DCI or the second-stage DCI is indicative of a future transmission intended for the apparatus.

In certain aspects, the timer is a bandwidth part (BWP) inactivity timer, and wherein the timer is started or restarted if at least one of the first-stage DCI or the second-stage DCI schedules a downlink assignment or an uplink grant via an active BWP associated with the apparatus.

In certain aspects, the timer is a secondary cell (SCell) deactivation timer, and wherein the timer is started or restarted if at least one of the first-stage DCI or the second-stage DCI is obtained via an active SCell link associated with the SCell deactivation timer.

In certain aspects, the timer is a secondary cell (SCell) deactivation timer, and wherein the timer is started or restarted if: the first-stage DCI is obtained via an active primary cell (PCell) link, and the first-stage DCI schedules a downlink assignment or an uplink grant for a communication between the apparatus and an active SCell associated with the SCell deactivation timer.

In certain aspects, the timer is a search space set group (SSSG) timer, and wherein the timer is started or restarted if of the first-stage or the second-stage DCI is obtained via an active search space.

In certain aspects, the active search space is a common search space (CSS) or a user-equipment (UE) specific search space (USS).

In certain aspects, the timer is a full-duplex switching timer, and wherein the timer is started or restarted if of the first-stage or second-stage DCI scheduled a full-duplex communication.

In certain aspects, the first-stage DCI comprises an indication of whether to start or restart the timer after receiving the second-stage DCI.

In certain aspects, the indication of whether to start or restart the timer is realized via at least one of a field or a radio network temporary identifier (RNTI) in the first-stage DCI.

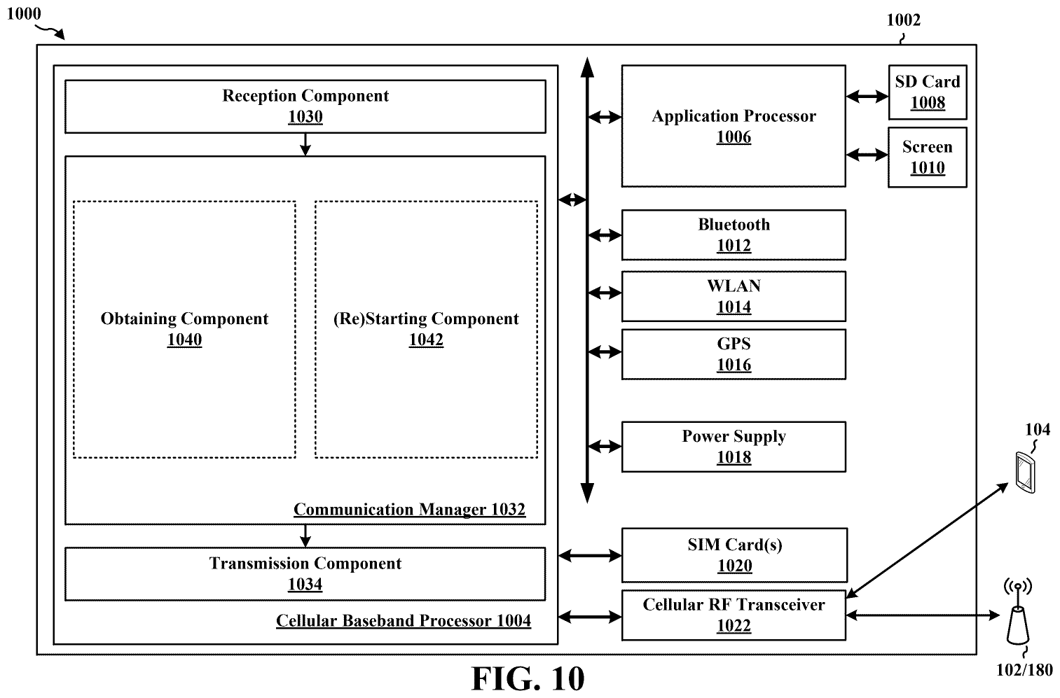

FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 that is configured to obtain a configuration message indicative of whether the start or restart of the timer occurs after receiving the first-stage DCI or after receiving the second-stage DCI; obtain a first-stage downlink control information (DCI) of a multi-stage DCI messaging scheme, wherein the first-stage DCI is configured to schedule transmission of a second-stage DCI; and obtain the second-stage DCI; e.g., as described in connection with 902, 904, and 906 of FIG. 9.

The communication manager 1032 further includes a (re)starting component 1042 configured to start or restart a timer after receiving at least one of the first-stage DCI or the second-stage DCI, e.g., as described in connection with 908 of FIG. 9.

The apparatus may include additional components that perform each of the blocks of the algorithm in the aforementioned flowchart of FIG. 9. As such, each block in FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for obtaining a configuration message indicative of whether the start or restart of the timer occurs after receiving the first-stage DCI or after receiving the second-stage DCI; means for obtaining a first-stage downlink control information (DCI) of a multi-stage DCI messaging scheme, wherein the first-stage DCI is configured to schedule transmission of a second-stage DCI; means for obtaining the second-stage DCI; and means for starting or restarting a timer after receiving at least one of the first-stage DCI or the second-stage DCI. The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

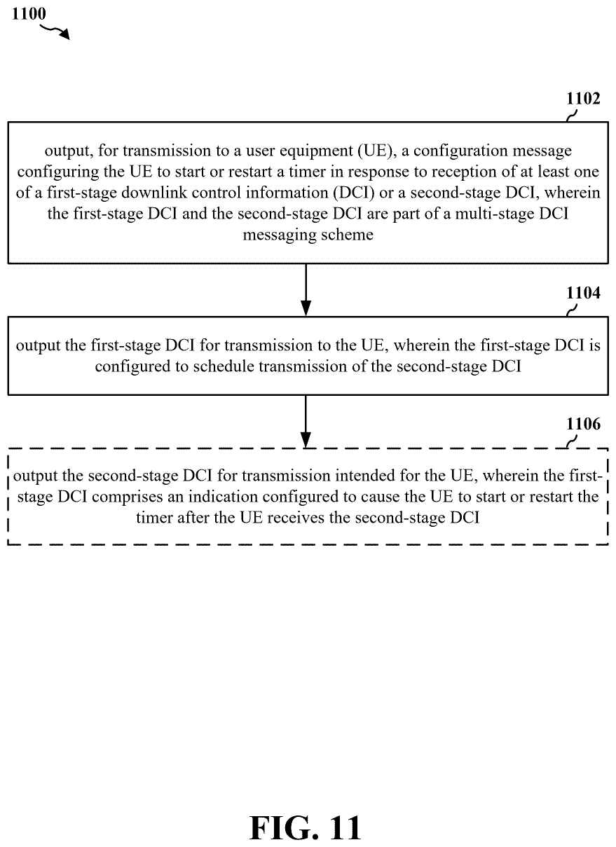

FIG. 11 is a flowchart 1100 of a method of wireless communication. The method may be performed by a base station (e.g., the base station 102/180; the apparatus 1202). Specifically, the method may be performed by one or more processors (e.g., the controller/processor 375, the Tx processor 316, the Rx processor 370, etc., of FIG. 3).

At 1102, the base station may output, for transmission to a user equipment (UE), a configuration message configuring the UE to start or restart a timer in response to reception of at least one of a first-stage downlink control information (DCI) or a second-stage DCI, wherein the first-stage DCI and the second-stage DCI are part of a multi-stage DCI messaging scheme. For example, 1102 may be performed by an outputting component 1240.

At 1104, the base station may output the first-stage DCI for transmission to the UE, wherein the first-stage DCI is configured to schedule transmission of the second-stage DCI. For example, 1104 may be performed by the outputting component 1240.

At 1106, the base station may optionally output the second-stage DCI for transmission intended for the UE, wherein the first-stage DCI comprises an indication configured to cause the UE to start or restart the timer after the UE receives the second-stage DCI. For example, 1106 may be performed by the outputting component 1240.

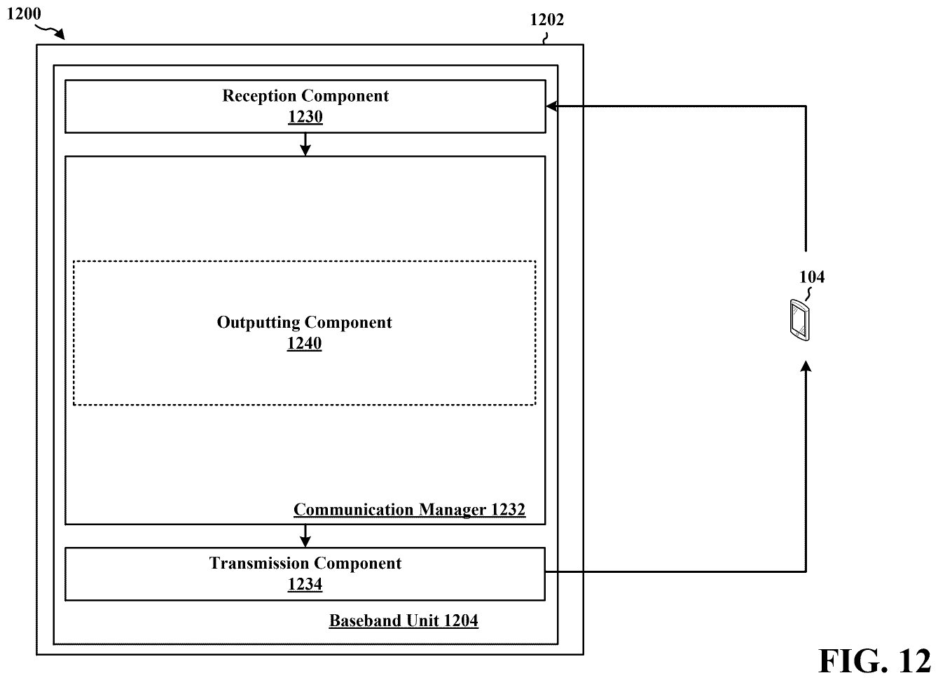

FIG. 12 is a diagram 1200 illustrating an example of a hardware implementation for an apparatus 1202. The apparatus 1202 is a BS and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/180 and may include the memory 376 and/or at least one of the TX processor 316, the RX processor 370, and the controller/processor 375. In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes an outputting component 1240 configured to: output, for transmission to a user equipment (UE), a configuration message configuring the UE to start or restart a timer in response to reception of at least one of a first-stage downlink control information (DCI) or a second-stage DCI, wherein the first-stage DCI and the second-stage DCI are part of a multi-stage DCI messaging scheme; output the first-stage DCI for transmission to the UE, wherein the first-stage DCI is configured to schedule transmission of the second-stage DCI; and output the second-stage DCI for transmission intended for the UE, wherein the first-stage DCI comprises an indication configured to cause the UE to start or restart the timer after the UE receives the second-stage DCI; e.g., as described in connection with 1102, 1104, and 1106 of FIG. 11.

The apparatus may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for output, for transmission to a user equipment (UE), a configuration message configuring the UE to start or restart a timer in response to reception of at least one of a first-stage downlink control information (DCI) or a second-stage DCI, wherein the first-stage DCI and the second-stage DCI are part of a multi-stage DCI messaging scheme; means for outputting the first-stage DCI for transmission to the UE, wherein the first-stage DCI is configured to schedule transmission of the second-stage DCI; and means for outputting the second-stage DCI for transmission intended for the UE, wherein the first-stage DCI comprises an indication configured to cause the UE to start or restart the timer after the UE receives the second-stage DCI.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

### ADDITIONAL CONSIDERATIONS

Means for receiving or means for obtaining may include a receiver, such as the receive processor 356/370 and/or an antenna(s) 320/352 of the BS 102/180 and UE 104 illustrated in FIG. 3. Means for transmitting or means for outputting may include a transmitter, such as the transmit processor 316/368 and/or an antenna(s) 320/352 of the BS 102/180 and UE 104 illustrated in FIG. 3. Means for starting, means for restarting, means for estimating, means for determining, means for measuring, and/or means for performing may include a processing system, which may include one or more processors, such as the controller/processor 375/359 of the BS 102/180 and the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a wireless node, comprising: obtaining a first-stage downlink control information (DCI) of a multi-stage DCI messaging scheme, wherein the first-stage DCI is configured to schedule transmission of a second-stage DCI; obtaining the second-stage DCI; and starting or restarting a timer after receiving at least one of the first-stage DCI or the second-stage DCI.

Example 2 is the method of Example 1, further comprising: obtaining a configuration message indicative of whether the start or restart of the timer occurs after receiving the first-stage DCI or after receiving the second-stage DCI.

Example 3 is the method of Example 2, wherein the configuration message is further indicative of at least one of a time at which the start or restart of the timer occurs.

Example 4 is the method of any of Examples 2 and 3, wherein the first-stage DCI is further configured to schedule transmission of multiple second-stage DCIs including the second-stage DCI, and wherein the configuration message is further indicative of the second-stage DCI triggering the start or restart of the timer.

Example 5 is the method of any of Examples 1-4, wherein the timer is configured with a duration of time for operations associated with both a single-stage DCI messaging scheme and the multi-stage DCI messaging scheme.

Example 6 is the method of any of Examples 1-5, wherein the timer is configured with a first duration of time for operations associated with a single-stage DCI messaging scheme, wherein the timer is configured with a second duration of time for operations associated with the multi-stage DCI messaging scheme, and wherein the first duration of time is different than the second duration of time.

Example 7 is the method of any of Examples 1-6, wherein the timer is configured with a duration of time for both the first-stage DCI and the second-stage DCI.

Example 8 is the method of any of Examples 1-7, wherein the timer is configured with a first duration of time for operations associated with first-stage DCI, wherein the timer is configured with a second duration of time for operations associated with the second-stage DCI, and wherein the first duration of time is different than the second duration of time.

Example 9 is the method of any of Examples 1-8, wherein the timer is a discontinuous reception (DRX) inactive timer, and wherein the timer is started or restarted if at least one of the first-stage DCI or the second-stage DCI is indicative of a future transmission intended for the wireless node.

Example 10 is the method of any of Examples 1-9, wherein the timer is a bandwidth part (BWP) inactivity timer, and wherein the timer is started or restarted if at least one of the first-stage DCI or the second-stage DCI schedules a downlink assignment or an uplink grant via an active BWP associated with the wireless node.

Example 11 is the method of any of Examples 1-10, wherein the timer is a secondary cell (SCell) deactivation timer, and wherein the timer is started or restarted if at least one of the first-stage DCI or the second-stage DCI is obtained via an active SCell link associated with the SCell deactivation timer.

Example 12 is the method of any of Examples 1-11, wherein the timer is a secondary cell (SCell) deactivation timer, and wherein the timer is started or restarted if: the first-stage DCI is obtained via an active primary cell (PCell) link, and the first-stage DCI schedules a downlink assignment or an uplink grant for a communication between the wireless node and an active SCell associated with the SCell deactivation timer.

Example 13 is the method of any of Examples 1-12, wherein the timer is a search space set group (SSSG) timer, and wherein the timer is started or restarted if of the first-stage or the second-stage DCI is obtained via an active search space.

Example 14 is the method of Example 13, wherein the active search space is a common search space (CSS) or a user-equipment (UE) specific search space (USS).

Example 15 is the method of any of Examples 1-14, wherein the timer is a full-duplex switching timer, and wherein the timer is started or restarted if of the first-stage or second-stage DCI scheduled a full-duplex communication.

Example 16 is the method of any of Examples 1-15, wherein the first-stage DCI comprises an indication of whether to start or restart the timer after receiving the second-stage DCI.

Example 17 is the method of Example 16, wherein the indication of whether to start or restart the timer is realized via at least one of a field or a radio network temporary identifier (RNTI) in the first-stage DCI.

Example 18 is a method for wireless communication at a wireless node, comprising: outputting, for transmission to a wireless node, a configuration message configuring the wireless node to start or restart a timer in response to reception of at least one of a first-stage downlink control information (DCI) or a second-stage DCI, wherein the first-stage DCI and the second-stage DCI are part of a multi-stage DCI messaging scheme; and outputting the first-stage DCI for transmission to the wireless node, wherein the first-stage DCI is configured to schedule transmission of the second-stage DCI.

Example 19 is the method of Example 18, wherein the configuration message is further indicative of at least one of a time at which the start or restart of the timer occurs.

Example 20 is the method of any of Examples 18 and 19, wherein the first-stage DCI is further configured to schedule transmission of multiple second-stage DCIs including the second-stage DCI, and wherein the configuration message is further indicative of the second-stage DCI triggering the start or restart of the timer.

Example 21 is the method of any of Examples 18-20, wherein the configuration message is further indicative of whether the timer is a discontinuous reception (DRX) inactive timer, a bandwidth part (BWP) inactivity timer, a secondary cell (SCell) deactivation timer, a search space set group (SSSG) timer, or a full-duplex switching timer.

Example 22 is the method of any of Examples 18-21, wherein the timer is a discontinuous reception (DRX) inactive timer, and wherein the configuration message further configures the wireless node to start or restart the timer if at least one of the first-stage DCI or the second-stage DCI schedules a future transmission intended for the wireless node.

Example 23 is the method of any of Examples 18-22, wherein the timer is a bandwidth part (BWP) inactivity timer, and wherein the configuration message further configures the wireless node to start or restart the timer if at least one of the first-stage DCI or the second-stage DCI schedules a downlink assignment or an uplink grant via an active BWP of the network entity.

Example 24 is the method of any of Examples 18-23, wherein the timer is a secondary cell (SCell) deactivation timer, and wherein the configuration message further configures the wireless node to start or restart the timer if at least one of the first-stage DCI or the second-stage DCI is output for transmission via an active SCell link associated with the SCell deactivation timer.

Example 25 is the method of any of Examples 18-24, wherein the timer is a secondary cell (SCell) deactivation timer, and wherein the configuration message further configures the wireless node to start or restart the timer if: the first-stage DCI is output for transmission via an active primary cell (PCell) link, and the first-stage DCI schedules a downlink assignment or an uplink grant for a communication between the wireless node and an active SCell associated with the SCell deactivation timer.

Example 26 is the method of any of Examples 18-25, wherein the timer is a search space set group (SSSG) timer, and wherein the configuration message further configures the wireless node to start or restart the timer if at least one of the first-stage or the second-stage DCI is output for transmission via an active search space.

Example 27 is the method of Example 26, wherein the active search space is a common search space (CSS) or a user-equipment (UE) specific search space (USS).

Example 28 is the method of any of Examples 18-27, wherein the timer is a full-duplex switching timer, and wherein the configuration message further configures the wireless node to start or restart the timer if at least one of the first-stage or second-stage DCI scheduled a full-duplex communication.

Example 29 is the method of any of Examples 18-28, further comprising: outputting the second-stage DCI for transmission intended for the wireless node, wherein the first-stage DCI comprises an indication configured to cause the wireless node to start or restart the timer after the wireless node receives the second-stage DCI.

Example 30 is the method of Example 29, wherein the indication configured to cause the wireless node to start or restart the timer is at least one of a field or a radio network temporary identifier (RNTI) in the first-stage DCI.

Example 31 is an apparatus for wireless communications, comprising means for performing a method in accordance with any one of examples 1-17.

Example 32 is an apparatus for wireless communications, comprising means for performing a method in accordance with any one of examples 18-30.

Example 33 is a non-transitory computer-readable medium comprising instructions that, when executed by a wireless node, cause the wireless node to perform a method in accordance with any one of examples 1-17.

Example 34 is a non-transitory computer-readable medium comprising instructions that, when executed by a wireless node, cause the wireless node to perform a method in accordance with any one of examples 18-30.

Example 35 is an apparatus for wireless communications, comprising: one or more memories, individually or in combination, having instructions; and one or more processors, individually or in combination, configured to execute the instructions and cause the apparatus to perform a method in accordance with any one of examples 1-17.

Example 36 is an apparatus for wireless communications, comprising: one or more memories, individually or in combination, having instructions; and one or more processors, individually or in combination, configured to execute the instructions and cause the apparatus to perform a method in accordance with any one of examples 18-30.

Example 37 is a user equipment (UE), comprising: a transceiver; one or more memories, individually or in combination, having instructions; and one or more processors, individually or in combination, configured to execute the instructions and cause the UE to perform a method in accordance with any one of examples 1-17, wherein the transceiver is configured to: receive the first-stage DCI of the multi-stage DCI messaging scheme; and receive the second-stage DCI.

Example 38 is a network entity, comprising: a transceiver; one or more memories, individually or in combination, having instructions; and one or more processors, individually or in combination, configured to execute the instructions and cause the network entity to perform a method in accordance with any one of examples 18-30, wherein the transceiver is configured to: transmit the configuration message; and transmit the first-stage DCI.

What is claimed is:

1. An apparatus for wireless communication, comprising:
one or more memories, individually or in combination, having instructions; and
one or more processors, individually or in combination, configured to execute the instructions and cause the apparatus to:
obtain a first-stage downlink control information (DCI) of a multi-stage DCI messaging scheme, wherein the first-stage DCI is configured to schedule transmission of a second-stage DCI;
obtain the second-stage DCI; and
start or restart a timer after receiving at least one of the first-stage DCI or the second-stage DCI.

2. The apparatus of claim 1, wherein the one or more processors, individually or in combination, are further configured to cause the apparatus to:
obtain a configuration message indicative of whether the start or restart of the timer occurs after receiving the first-stage DCI or after receiving the second-stage DCI.

3. The apparatus of claim 2, wherein the configuration message is further indicative of at least one of a time at which the start or restart of the timer occurs.

4. The apparatus of claim 2, wherein the first-stage DCI is further configured to schedule transmission of multiple second-stage DCIs including the second-stage DCI, and wherein the configuration message is further indicative of the second-stage DCI triggering the start or restart of the timer.

5. The apparatus of claim 1, wherein the timer is configured with a duration of time for operations associated with both a single-stage DCI messaging scheme and the multi-stage DCI messaging scheme.

6. The apparatus of claim 1, wherein the timer is configured with a first duration of time for operations associated with a single-stage DCI messaging scheme, wherein the timer is configured with a second duration of time for operations associated with the multi-stage DCI messaging scheme, and wherein the first duration of time is different than the second duration of time.

7. The apparatus of claim 1, wherein the timer is configured with a duration of time for both the first-stage DCI and the second-stage DCI.

8. The apparatus of claim 1, wherein the timer is configured with a first duration of time for operations associated with first-stage DCI, wherein the timer is configured with a second duration of time for operations associated with the second-stage DCI, and wherein the first duration of time is different than the second duration of time.

9. The apparatus of claim 1, wherein the timer is a discontinuous reception (DRX) inactive timer, and wherein the timer is started or restarted if at least one of the first-stage DCI or the second-stage DCI is indicative of a future transmission intended for the apparatus.

10. The apparatus of claim 1, wherein the timer is a bandwidth part (BWP) inactivity timer, and wherein the timer is started or restarted if at least one of the first-stage DCI or the second-stage DCI schedules a downlink assignment or an uplink grant via an active BWP associated with the apparatus.

11. The apparatus of claim 1, wherein the timer is a secondary cell (SCell) deactivation timer, and wherein the timer is started or restarted if at least one of the first-stage DCI or the second-stage DCI is obtained via an active SCell link associated with the SCell deactivation timer.

12. The apparatus of claim 1, wherein the timer is a secondary cell (SCell) deactivation timer, and wherein the timer is started or restarted if:
the first-stage DCI is obtained via an active primary cell (PCell) link, and
the first-stage DCI schedules a downlink assignment or an uplink grant for a communication between the apparatus and an active SCell associated with the SCell deactivation timer.

13. The apparatus of claim 1, wherein the timer is a search space set group (SSSG) timer, and wherein the timer is started or restarted if of the first-stage or the second-stage DCI is obtained via an active search space.

14. The apparatus of claim 13, wherein the active search space is a common search space (CSS) or a user-equipment (UE) specific search space (USS).

15. The apparatus of claim 1, wherein the timer is a full-duplex switching timer, and wherein the timer is started or restarted if of the first-stage or second-stage DCI scheduled a full-duplex communication.

16. The apparatus of claim 1, wherein the first-stage DCI comprises an indication of whether to start or restart the timer after receiving the second-stage DCI, and wherein the indication of whether to start or restart the timer is realized via at least one of a field or a radio network temporary identifier (RNTI) in the first-stage DCI.

17. The apparatus of claim 1, further comprising a transceiver configured to:
receive the first-stage DCI; and
receive the second-stage DCI, wherein the apparatus is configured as a user equipment (UE).

18. An apparatus for wireless communication, comprising:
one or more memories, individually or in combination, having instructions; and
one or more processors, individually or in combination, configured to execute the instructions and cause the apparatus to:
output, for transmission to a user equipment (UE), a configuration message configuring the UE to start or restart a timer in response to reception of at least one of a first-stage downlink control information (DCI) or a second-stage DCI, wherein the first-stage DCI and the second-stage DCI are part of a multi-stage DCI messaging scheme; and
output the first-stage DCI for transmission to the UE, wherein the first-stage DCI is configured to schedule transmission of the second-stage DCI.

19. The apparatus of claim 18, wherein the configuration message is further indicative of at least one of a time at which the start or restart of the timer occurs.

20. The apparatus of claim 18, wherein the first-stage DCI is further configured to schedule transmission of multiple second-stage DCIs including the second-stage DCI, and wherein the configuration message is further indicative of the second-stage DCI triggering the start or restart of the timer.

21. The apparatus of claim 18, wherein the configuration message is further indicative of whether the timer is a discontinuous reception (DRX) inactive timer, a bandwidth part (BWP) inactivity timer, a secondary cell (SCell) deactivation timer, a search space set group (SSSG) timer, or a full-duplex switching timer.

22. The apparatus of claim 18, wherein the timer is a discontinuous reception (DRX) inactive timer, and wherein the configuration message further configures the UE to start or restart the timer if at least one of the first-stage DCI or the second-stage DCI schedules a future transmission intended for the UE.

23. The apparatus of claim 18, wherein the timer is a bandwidth part (BWP) inactivity timer, and wherein the configuration message further configures the UE to start or restart the timer if at least one of the first-stage DCI or the second-stage DCI schedules a downlink assignment or an uplink grant via an active BWP of the apparatus.

24. The apparatus of claim 18, wherein the timer is a secondary cell (SCell) deactivation timer, and wherein the configuration message further configures the UE to start or restart the timer if at least one of the first-stage DCI or the second-stage DCI is output for transmission via an active SCell link associated with the SCell deactivation timer.

25. The apparatus of claim 18, wherein the timer is a secondary cell (SCell) deactivation timer, and wherein the configuration message further configures the UE to start or restart the timer if:
the first-stage DCI is output for transmission via an active primary cell (PCell) link, and
the first-stage DCI schedules a downlink assignment or an uplink grant for a communication between the UE and an active SCell associated with the SCell deactivation timer.

26. The apparatus of claim 18, wherein the timer is a search space set group (SSSG) timer, and wherein the configuration message further configures the UE to start or restart the timer if at least one of the first-stage or the second-stage DCI is output for transmission via an active search space.

27. The apparatus of claim 18, wherein the timer is a full-duplex switching timer, and wherein the configuration message further configures the UE to start or restart the timer if at least one of the first-stage or second-stage DCI scheduled a full-duplex communication.

28. The apparatus of claim 18, wherein the one or more processors, individually or in combination, are further configured to cause the apparatus to:
output the second-stage DCI for transmission intended for the UE, wherein the first-stage DCI comprises an indication configured to cause the UE to start or restart the timer after the UE receives the second-stage DCI, and wherein the indication configured to cause the UE to start or restart the timer is at least one of a field or a radio network temporary identifier (RNTI) in the first-stage DCI.

29. The apparatus of claim 19, further comprising a transceiver configured to:
transmit the configuration message; and
transmit the first-stage DCI, wherein the apparatus is configured as a network entity.

30. A method for wireless communications at a wireless node, comprising:
obtaining a first-stage downlink control information (DCI) of a multi-stage DCI messaging scheme, wherein the first-stage DCI is configured to schedule transmission of a second-stage DCI;
obtaining the second-stage DCI; and
starting or restarting a timer after receiving at least one of the first-stage DCI or the second-stage DCI.
